(19) United States
(12) Patent Application Publication
(10) Pub. No.: US 2010/0030898 A1
(43) Pub. Date: Feb. 4, 2010

(54) NETWORK SETTING METHOD AND NETWORK SETTING APPARATUS

(75) Inventors: Yuji Imai, Kawasaki (JP); Andreas Savva, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/473,090

(22) Filed: May 27, 2009

(30) Foreign Application Priority Data
Aug. 1, 2008 (JP) 2008-199818

(51) Int. Cl. G06F 15/16; G06F 9/00; G06F 9/455

(52) U.S. Cl. 709/227; 726/15; 718/1

(57) ABSTRACT

An administrative manager connected to a plurality of servers each including a virtual machine environment in which a host OS and a guest OS are operable as virtual OS, performs the following processes. Namely, when the guest OS is started up in the server, the information whether or not transmission and reception of data among service programs is necessary and the information of the servers executing the service programs are referred to. Then, the connection target server which performs communications with the server in which the guest OS is started up, is determined according to the service program to be executed in the starting objective server. Further, the connection information is set to the host OS that operates in the starting objective server and to the host OS that operates in the connection target server.

### CROSS-REFERENCE TO RELATED APPLICATION

This application is based upon and claims the benefit of priority of the prior Japanese Patent Application No. 2008-199818, filed on Aug. 1, 2008, the entire contents of which are incorporated herein by reference.

### FIELD

The embodiment discusses herein is directed to a technology for performing network setting on servers each of which is applied with a virtualization technology, for the purpose of performing communications among the servers.

### BACKGROUND

In recent years, demands for implementing outsourcing of information processing systems of service enterprises and the like are increased, and the market thereof is expanded. A data center collectively undertaking such outsourcing includes a server node pool configured by a plurality of servers. Then, service programs for processing customers' services of which outsourcings are consigned are discretely allocated to the plurality of servers configuring the server node pool, according to functions thereof, and also, these servers are physically network-connected.

In the server node pool described above, in order to separately administrate the services of the plurality of customers, a technology for setting a virtual machine environment in each server is generalized. To be specific, in each server, as a virtual operating system (hereunder, “operating system” is to be referred to as an OS (operating system), i.e., virtual OS, and the same rule will be applied to other operating systems), a host OS being a basis in the virtual machine environment is operated, and also, a guest OS as an environment for executing the service program is operated. Thus, even in the case where the service programs for the plurality of customers are processed on the same server, it is possible to avoid that data processed by the service programs for the customers are mixed among the customers.

Further, in such a server node pool, since the physical network among the servers is shared by the plurality of customers, in order to avoid information leakage among the customers, unauthorized access and the like, a method described below is further adopted. Namely, the physical network among the servers is sectioned in L2 (Layer-2) sections using a VLAN (Virtual Local Area Network) technology or is sectioned using a VPN (Virtual Private Network) technology to thereby virtually divide the physical network, so that a virtual intranet is set up for each customer.

Here, in operations of such a system, it is naturally assumed that, in accordance with changes in customers' services, a burden is concentrated onto a specific service program. In such a case, a guest operating system is newly started up in the server which has not executed the specific service program until now, to thereby make the server to execute this specific service program. Then, this server executing the specific service program is newly and virtually network-connected to another server executing the service program in cooperative with the specific service program, so that data is transmitted and received between these servers. Thus, the burden balancing is provided, and consequently, it is possible to avoid troubles that may arise (refer to Japanese National Publication of International Patent Application No. 2004-503011).

However, in the case where the guest OS is newly started up to be virtually connected to another server, the burden on the network setting work is considerably large. This is because a function of newly starting up the guest OS in the server is not in cooperative with a function of setting the virtual network connection for the newly started guest OS. Therefore, it is necessary to perform individually and manually the setting of the virtual network connection. Further, since the cooperative service program depends on the function of the service program executed in each of the newly started guest OS, it is difficult to grasp the cooperative service program. Furthermore, even if it is possible to grasp the cooperative service program, it is further difficult to specify what guest OS in what server among enormous number of servers executes this cooperative service program. Still further, the number of servers configuring the server node pool is enormous, and a network configuration of the server node pool is complicated, and also, the servers configuring the server node pool is divided by the virtual network, and thus, it is also necessary to perform switch setting, tunneling setting and the like. Therefore, it is considerably complicate and difficult to perform the network connection setting of the servers when the guest OS is newly started up. Moreover, since the burden on the setting work is large, mistakes during the setting work are susceptible to arise.

### SUMMARY

According to an aspect of the embodiment, a computer connected to a plurality of servers each including a virtual machine environment in which a host OS and a guest OS are operable as virtual OS, executes the following processes. Namely, when the guest OS is started up in a server, the computer refers to a table in which whether or not transmission and reception of data among service programs is necessary, is set and a table in which the servers executing the service programs are set. Then, the computer determines a connection target server which is to perform communications with the server in which the guest OS is newly started up, according to the service program to be executed by the newly started guest OS. Further, the computer acquires connection information necessary for performing virtual network communications between the server in which the guest OS is newly started up and the connection target server. Furthermore, the computer sets the acquired connection information to the host OS that operates in the server in which the guest OS is newly started up and to the host OS that operates in the connection target server.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an entire configuration view of a system providing a network setting mechanism;

FIG. 2 is an explanatory view of a server configuration and a structure of data transfer between two servers;

FIG. 3A is an explanatory view of a setting table of a routing section;

FIG. 3B is an explanatory view of a setting table of a tunneling section;

FIG. 4 is a configuration view of an administrative manager;

FIG. 5 is an explanatory view of a connecting course table;

FIG. 6 is an explanatory view of a service administration table;

FIG. 7 is an explanatory view of a physical IP address table;

FIG. 8 is an explanatory view of an interface administration table;

FIG. 9 is an explanatory view of a VPN connection example among servers;

FIG. 10 is a flowchart of a network setting process by the administrative manager;

FIG. 11 is an explanatory view of a server configuration before processing network setting, in a specific example of the network setting process;

FIG. 12A is an explanatory view of the connecting course table before processing the network setting, in the specific example of the network setting process;

FIG. 12B is an explanatory view of the physical IP address table before processing the network setting, in the specific example of the network setting process;

FIG. 12C is an explanatory view of the service administration table before processing the network setting, in the specific example of the network setting process;

FIG. 12D is an explanatory view of the interface administration table before processing the network setting, in the specific example of the network setting process;

FIG. 13A is an explanatory view of the setting table of the routing section in the server α before processing the network setting, in the specific example of the network setting process;

FIG. 13B is an explanatory view of the setting table of the tunneling section in the server α before processing the network setting, in the specific example of the network setting process;

FIG. 14A is an explanatory view of the setting table of the routing section in the server γ before processing the network setting, in the specific example of the network setting process;

FIG. 14B is an explanatory view of the setting table of the tunneling section in the server γ before processing the network setting, in the specific example of the network setting process;

FIG. 15 is an explanatory view of the server configuration after processing the network setting, in the specific example of the network setting process;

FIG. 16A is an explanatory view of the setting table of the tunneling section in the server α after processing the network setting, in the specific example of the network setting process;

FIG. 16B is an explanatory view of the setting table of the routing section in the server α after processing the network setting, in the specific example of the network setting process;

FIG. 17A is an explanatory view of the setting table of the tunneling section in the server γ after processing the network setting, in the specific example of the network setting process;

FIG. 17B is an explanatory view of the setting table of the routing section in the server γ after processing the network setting, in the specific example of the network setting process;

FIG. 18A is an explanatory view of the service administration table after processing the network setting, in the specific example of the network setting process; and

FIG. 18B is an explanatory view of the interface administration table after processing the network setting, in the specific example of the network setting process.

### DESCRIPTION OF EMBODIMENT

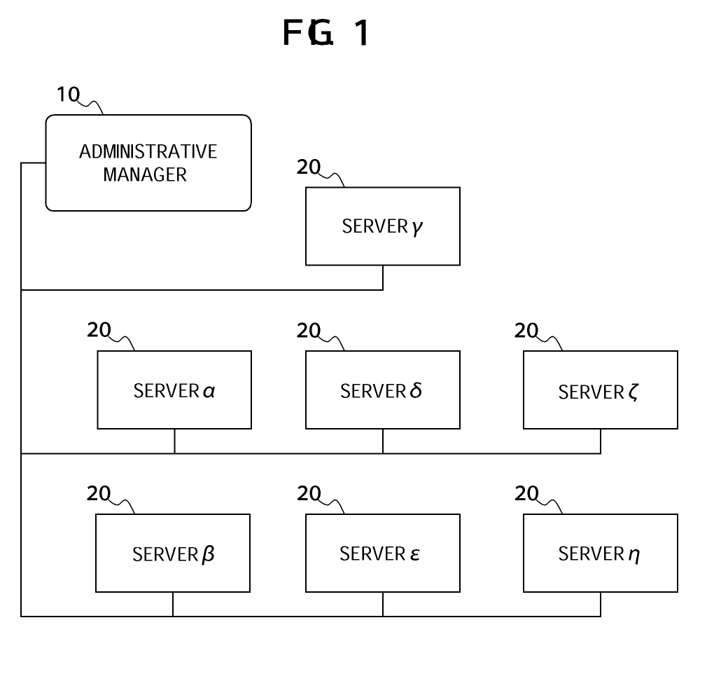

FIG. 1 illustrates an entire configuration of a system providing a network setting mechanism. This system is the one set up in a server node pool installed in a data center that collectively administrates plural customers' services, and in this system, an administrative manager 10 and a plurality of servers 20 processing the customers' services are network-connected. The administrative manager 10 administrates the entirety of servers 20 in lump, and also, performs various types of setting on the servers 20 by remote controls. Further, the administrative manager 10 and the servers 20 are all configured by computers each provided with at least a CPU (Central Processing Unit) and a memory.

In the plurality of servers 20 configuring the server node pool, service programs for processing the services of plural customers who consigned outsourcing to the data center are arranged. Further, each server 20 is provided with a virtual machine environment capable of operating a virtual OS. Furthermore, the servers 20 establish the VPN connection to one another in P2P (Peer to Peer) using a virtual (private) network (VPN: Virtual Private Network), and the system is divided for each customer to thereby set up a virtual intranet. Incidentally, the above virtual intranet divided for each customer is connected to own system of individual customer.

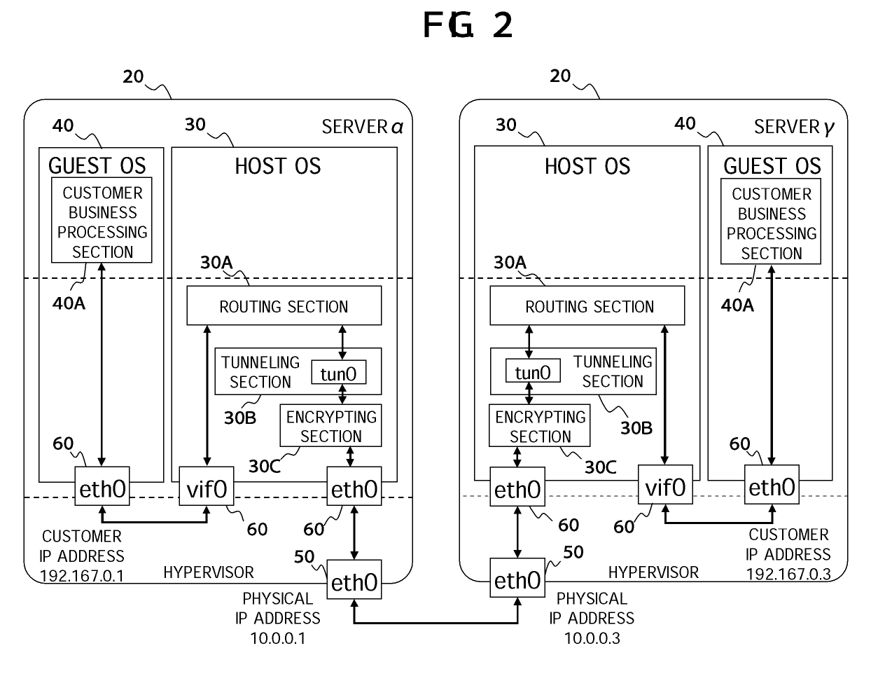

Next, referring FIG. 2, there will be described a configuration of each server 20 provided with the virtual machine environment and a structure of the VPN connection among the servers 20.

In the server 20, the virtual machine environment is set up, and a host OS 30 and a guest OS 40 operate as virtual OS. The host OS 30 and the guest OS 40 are controlled on a hypervisor functioning as an OS control program.

Further, the server 20 is provided with a physical NIC (Network Interface Card) 50 for performing communications with other computers. Then, the server 20 is allocated with a physical IP address which is uniquely identified in the server node pool. Furthermore, each of the host OS 30 and the guest OS 40 operating in the server 20 is provided with virtual NIC 60, and communications between the host OS 30 and the guest OS 40 in the same server are performed using this virtual NIC 60. Then, the guest OS 40 operating in the server is allocated with a customer IP address as a virtual IP address which is a unique address different from the physical IP address.

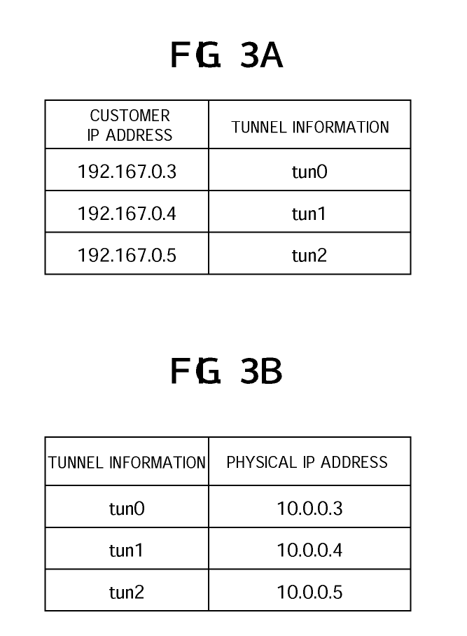

Further, the host OS 30 includes an element described below. Namely, the host OS 30 includes a routing section 30A that, when transmission data is received from the guest OS 40, specifies tunnel information for transmitting the transmission data via the VPN connection. As illustrated in FIG. 3A, the routing section 30A is provided with a routing setting table in which the customer IP addresses of the transmission targets and the tunnel information to be used for the VPN connection to the transmission target are set. Then, the routing section 30A refers to the routing setting table and specifies a tunnel to be used for VPN communications based on the customer IP address attached to the transmission data. Further, the host OS 30 includes a tunneling section 30B that attaches the physical IP address of the transmission target to the transmission data and also encapsulates the transmission data to thereby perform tunneling. As illustrated in FIG. 3B, the tunneling section 30B is provided with a tunneling setting table in which the tunnel information and the physical IP addresses being the transmission targets of the tunnels are set. Then, the tunneling section 30B specifies the physical IP address of the transmission target from the tunnel information, based on the tunneling setting table. Further, the host OS 30 includes an encrypting section 30C that encrypts the transmission data. Incidentally, when data is received from the other server 20, in the host OS 30, the received data is decrypted in the encrypting section 30C and encapsulation thereof is released in the tunneling section 30B, and also, the received data is transmitted to the guest OS 40 of the customer IP address attached to the received data.

On the other hand, the guest OS 40 includes a customer's service processing section 40A that executes the service program. Incidentally, in an example of FIG. 2, only one guest OS operates, but a plurality of guests OS can operate.

Here, referring the example of FIG. 2, there will be described a process of data transmission from the service program executed in the customer's service processing section 40A in the guest OS 40 of a server α to the service program executed in the customer's service processing section 40A in the guest OS 40 of a server γ. Firstly, the data is transmitted from the service program executed in the customer's service processing section 40A of the server α to the customer IP address (192.167.0.3) of the guest OS 40 of the server γ, which is the transmission target. This data is transmitted to the host OS 30 via the virtual NIC 60 (eth0) of the guest OS 40 and the virtual NIC 60 (vif0) of the host OS 30. Then, in the host OS 30, the routing setting table is referred to in the routing section 30A, to thereby acquire the tunnel information corresponding to the customer IP address of the transmission target. Further, in the host OS 30, the tunneling setting table is referred to in the tunneling section 30B, to thereby acquire the physical IP address (10.0.0.3) of the transmission target server corresponding to the tunnel information. Then, this physical IP address is attached to the transmission data, and thereafter, the transmission data is encapsulated and tunneled. Further, in the encrypting section 30C, the encapsulated transmission data is further encrypted by applying IPsec or the like. As a result, it becomes possible to establish the VPN connection to the server γ. Then, the transmission data is transmitted from the virtual NIC 60 (eth0) of the host OS 30 to the server γ via the physical NIC 50 (eth0) of the server α. On the other hand, in the host OS 30 of the server γ that received the transmission data, the reception data is transmitted to the guest OS 40 being the transmission target in which the service program is executed, based on the customer IP address attached to the reception data.

By adopting the configuration described above, in the case where the data transmission and reception is performed between the own server 20 and the other server 20 in the service program, in the guest OS 40, only the customer IP address of the transmission target may be set to the transmission data, and the setting of the physical IP address and the VPN connection is performed by the host OS 30. Therefore, when the customer accesses the server to execute the service program and communicate with the other server, it becomes possible to perform such communications without the necessity of directly controlling the host OS 30. Accordingly, it becomes possible to perform the communications with the other server without providing a control authorization of the host OS 30 to the customer, and consequently, it is possible to prevent troubles, such as erroneous alteration of the environment setting of the host OS 30 by the customer.

Next, there will be described the administrative manager 10 that administrates the entirety of servers 20 described above.

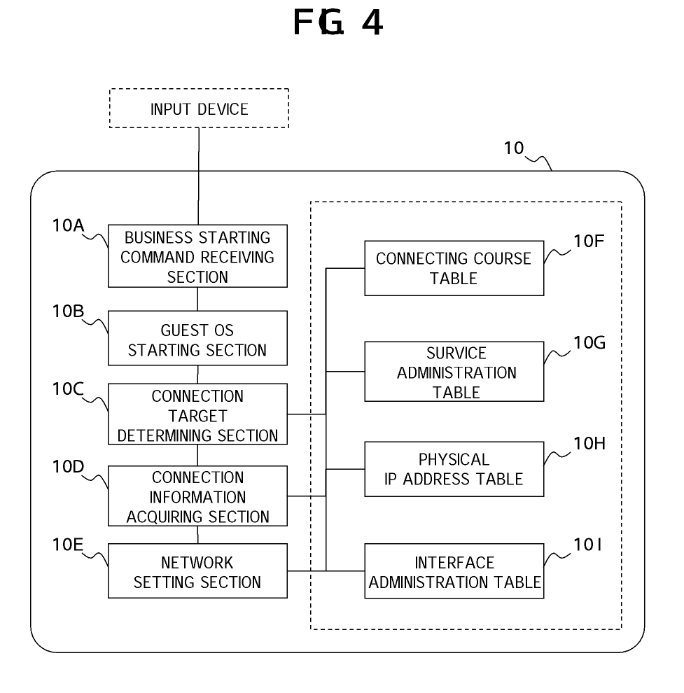

FIG. 4 is a configuration view of the administrative manager 10. The administrative manager 10 includes: a service starting command receiving section 10A; a guest OS starting section 10B; a connection target determining section 10C; a connection information acquiring section 10D; a network setting section 10E; a connecting course table 10F; a service administration table 10G; a physical IP address table 10H; and an interface administration table 10I.

The service starting command receiving section (unit) 10A is connected to an input device which can be operated by an operator. Then, the service starting command receiving section 10A receives a service starting command for newly starting up the guest OS 40 to execute the service program. In this service starting command, a starting objective server of which guest OS 40 is to be newly started up and the service program to be executed are designated.

The guest OS starting section 10B newly starts up the guest OS 40 of the server 20 in which the host OS 30 operates on the hypervisor and the guest OS 40 is operable, and also, makes the service program to be executable.

The connection target determining section 10C determines a connection target server which establishes the VPN connection to the starting objective server in which the guest OS 40 is started up.

The connection information acquiring section 10D acquires connection information necessary for establishing the VPN connection between the starting objective server and the connection target server.

The network setting section 10E is network-connected to each of the servers 20, to set the connection information to the host OS 30 of the starting objective server and the host OS 30 of the connection target server.

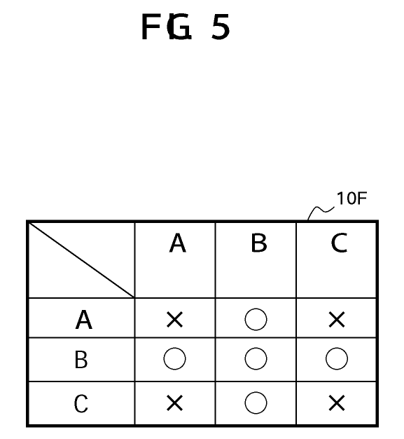

The connecting course table 10F indicates whether or not VPN connection among the service programs is available, according to service program types based on functions of the service programs, and as illustrated in FIG. 5, in the connecting course table 10F, it is registered whether or not the connection among the service program types is available. In the example of FIG. 5, respective A, B and C indicate the service program types, and “◯” indicates that the connection is available and “X” indicates that the connection is not available. Thus, according to the connecting course table 10F, it is possible to set both whether or not the connection among the service programs of same type is available and whether or not the connection among the service programs of different types is available.

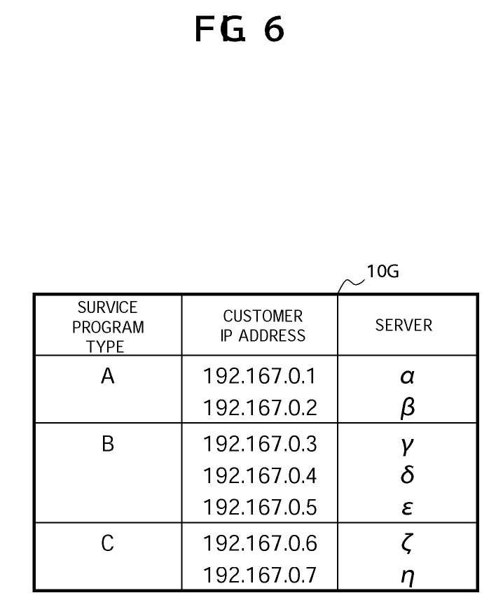

The service administration table 10G indicates for each of service program types, the servers 20 in which the service programs of respective service program types are executed. As illustrated in FIG. 6, in the service administration table 10G, the service program types, the customer IP addresses of the guests OS 40 executing the service programs of the service program types, and the server names are registered.

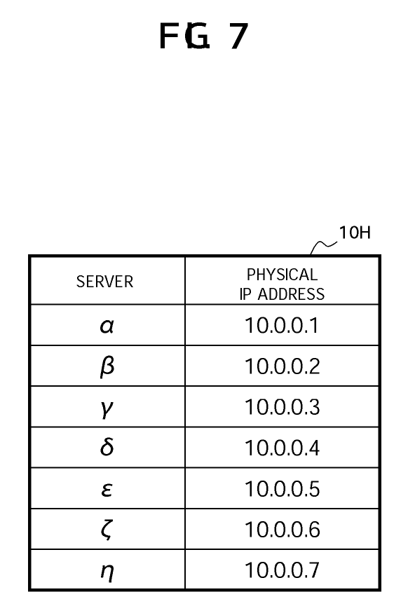

The physical IP address table 10H indicates the physical IP addresses of the servers 20, and as illustrated in FIG. 7, in the physical IP address table 10H, the servers and the physical IP addresses of the servers is registered.

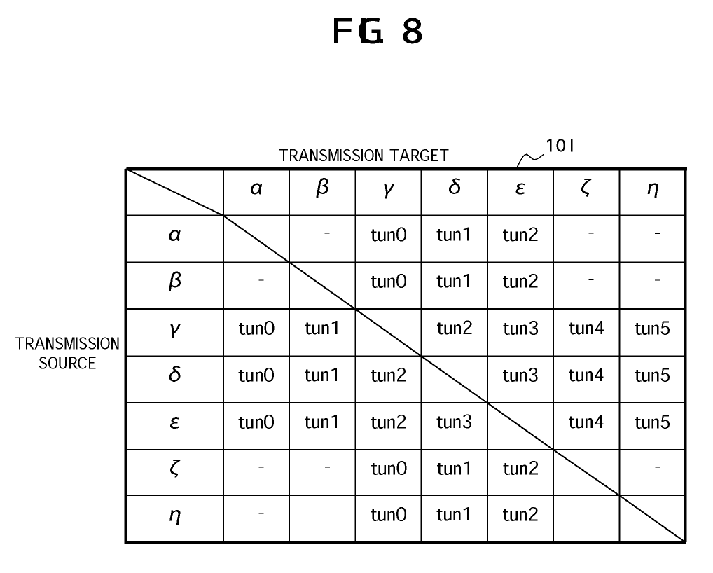

The interface administration table 10I indicates the tunnels to be used for the VPN connection among the servers 20, and as illustrated in FIG. 8, includes the transmission source servers and the transmission target servers, and also, the tunnel information.

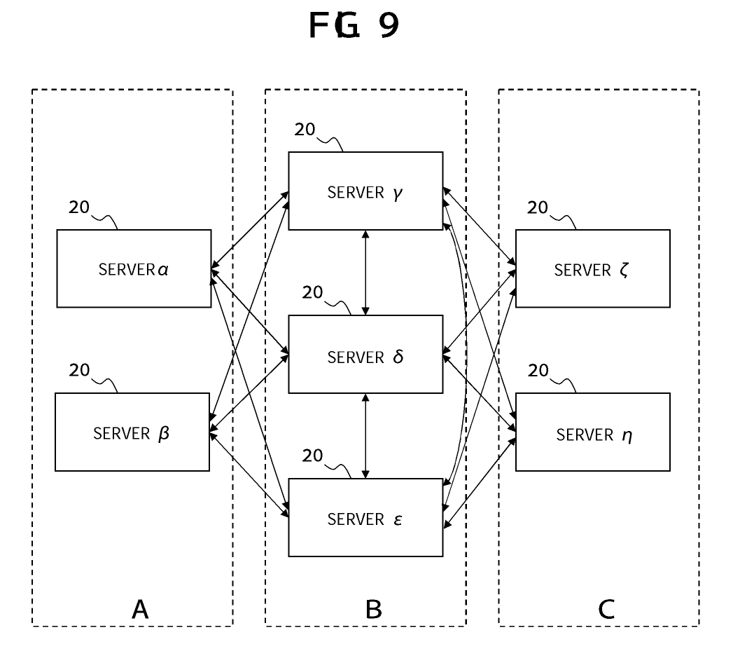

Here, there will be described how the VPN connection is established among the servers 20, based on whether or not the VPN connection according to the service program types registered in the above connecting course table 10F is available. FIG. 9 illustrates an example of the VPN connection among the servers 20 in the data example of the connecting course table 10F in FIG. 5. In this example, the server α and server β each executes the service program of service program type A, the server γ, server δ and server ε each executes the service program of service program type B, and the server ζ and server η each executes the service program of service program type C. Further, arrows in solid lines indicate that the VPN connection is established among the servers 20. Then, in the connecting course table 10F of FIG. 5, the connection between the service programs of service program type A and the connection between the service programs of service program types A and C are not available (X), whereas the connection between the service programs of service program types A and B, the connection between the service programs of service program types B and the connection between the service programs of service program types B and C are available (O). Therefore, as illustrated in FIG. 9, the server α and server β each executing the service programs of service program type A are each connected to the server γ, server δ and server ε each executing the service programs of service program type B. On the other hand, the server α and server β each executing the service program of service program type A are not connected to the server ζ and server η each executing the service program of service program type C. Further, the server γ, server δ and server ε each executing the service program of service program type B are mutually connected. Furthermore, the server γ, server δ and server ε each executing the service program of service program type B are each connected to the server ζ and server η each executing the service programs of service program type C.

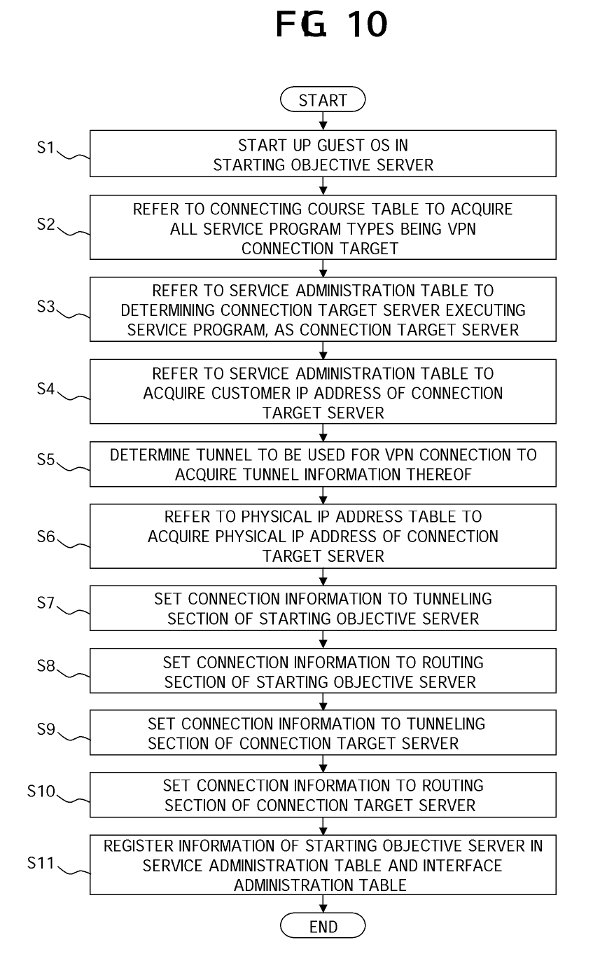

FIG. 10 illustrates a network setting process executed in the service starting command receiving section 10A, guest OS starting section 10B, connection target determining section 10C, connection information acquiring section 10D and network setting section 10E of the administrative manager 10. This process is executed when the operator issues the service starting command which designates the starting objective server in which the guest OS 40 is newly started up to execute the service program, and the service program to be executed.

In step 1 (to be abbreviated as S1 in FIG. 10, and the same rule will be applied to subsequent steps), the guest OS 40 is started up in the designated starting objective server, to thereby make the service program to be executable. At this time, a new customer IP address is allocated to the started guest OS 40. Incidentally, such customer IP address allocation is performed so that the new customer IP address does not overlap with the customer IP addresses which are already used.

In step 2, referring to the connecting course table 10F, all of the service program types necessary for establishing the VPN connection to the service program type of the service program designated by the service starting command, are acquired.

In step 3, referring to the service administration table 10G, the server 20 executing the service program of service program type acquired in step 2, is determined as the connection target server.

In step 4, referring to the service administration table 10G, the customer IP address of the guest OS 40 in the connection target server is acquired.

In step 5, a tunnel to be used for the VPN connection between the starting objective server and the connection target server is determined. Incidentally, such tunnel determination is performed so that the determined tunnel does not overlap with the tunnels in each server which are already used.

In step 6, referring to the physical IP address table 10H, the physical IP address of the connection target server is acquired.

In step 7, in order to establish the VPN connection from the starting objective server to the connection target server, in the tunneling section 30B of the starting objective server, a new tunnel is set in accordance with the tunnel information acquired in step 5. Further, the tunnel information of the new tunnel and the physical IP address of the connection target server are set, as the connection information, to the tunneling setting table in the tunneling section 30B of the starting objective server.

In step 8, the customer IP address of the connection target server and the tunnel information thereof are set, as the connection information, to the routing setting table in the routing section 30A of the starting objective server.

In step 9, in order to establish the VPN connection from the connection target server to the starting objective server, in the tunneling section 30B of the connection target server, a new tunnel is set. Further, the tunnel information of the new tunnel and the physical IP address of the starting objective server are set, as the connection information, to the tunneling setting table in the tunneling section 30B of the connection target server.

In step 10, the customer IP address of the starting objective server and the tunnel information thereof are set, as the connection information, to the routing setting table in the routing section 30A of the connection target server.

In step 11, the customer IP address, service program type and server name of the starting objective server are registered in the service administration table 10G of the administrative manager 10, and also, the tunnel information between the starting objective server and the connection target server is registered in the interface administration table 10I.

Incidentally, when a plurality of connection target servers is determined, the above steps 4 to 11 are executed for the plurality of connection target servers.

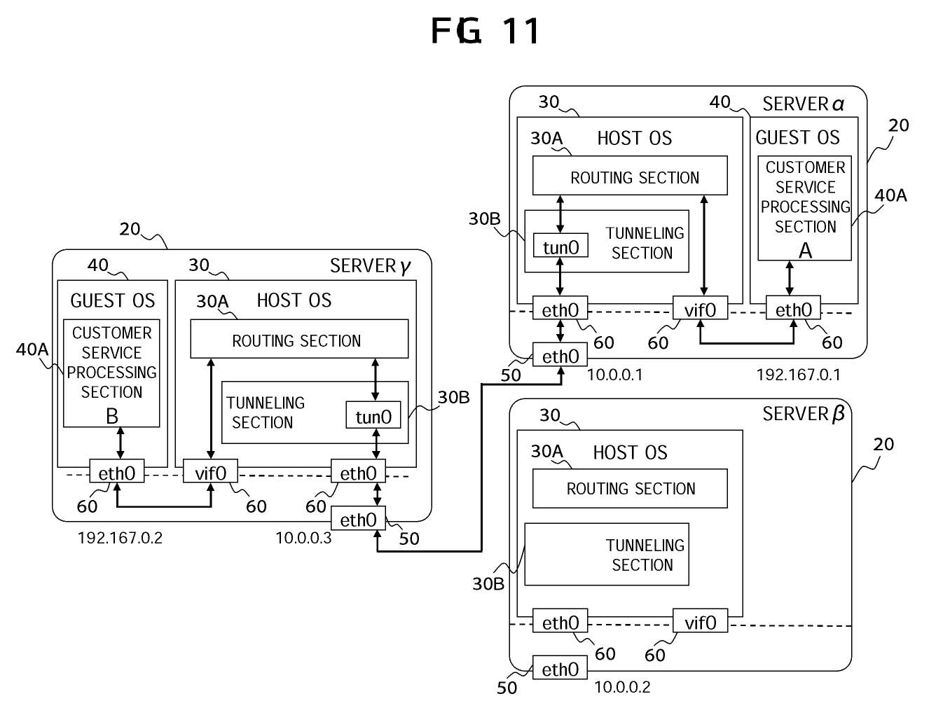

Here, there will be described the network setting process executed by the administrative manager 10 by indicating a specific example. Herein, an example of server configuration as illustrated in FIG. 11 is used. In this example, the server α executes the service program of service program type A, and the server γ executes the service program of service program type B. Then, it is assumed that a processing amount by the service program of service program type A is increased, so that a burden is imparted on the server α, and therefore, the service starting command is issued for newly starting up the guest OS 40 in the server β to execute the service program of service program type A. Incidentally, in FIG. 11, the illustration of physical network connection between the administrative manger 10 and each server, and the illustration of a part of the configuration of each server, are omitted for convenience. Further, an arrow in a solid line between servers indicates that the VPN connection is established.

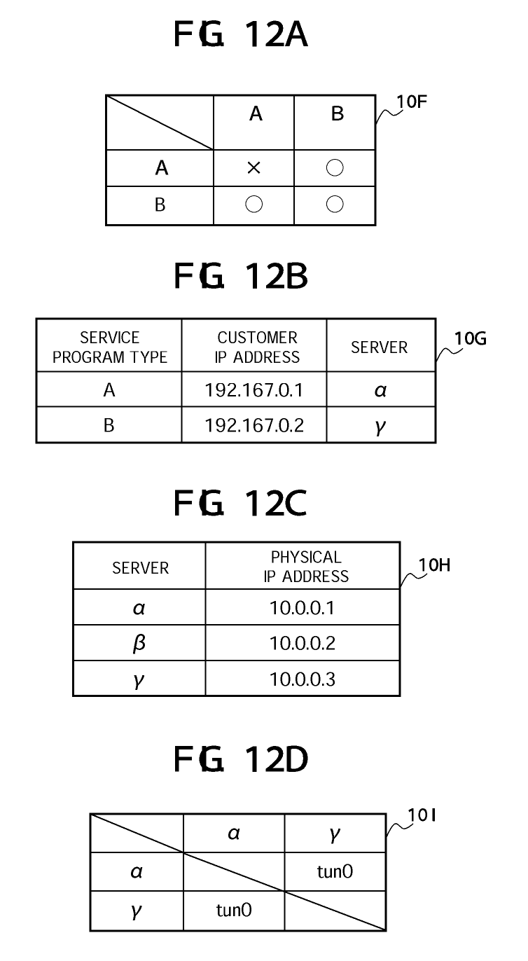

Further, in this example, the connecting course table 10F, service administration table 10G, physical IP address table 10H and interface administration table 10I of the administrative manager 10 are set as illustrated in FIG. 12A, FIG. 12B, FIG. 12C and FIG. 12D, respectively.

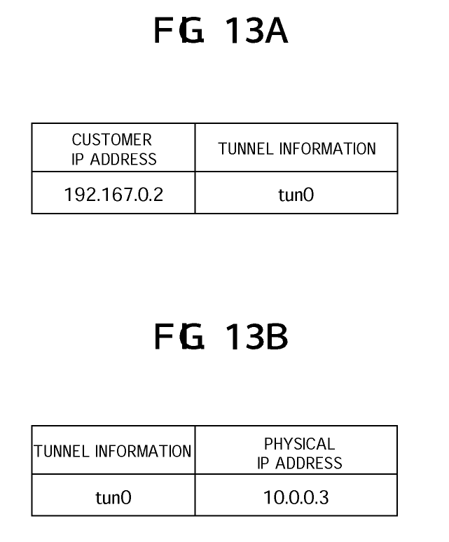

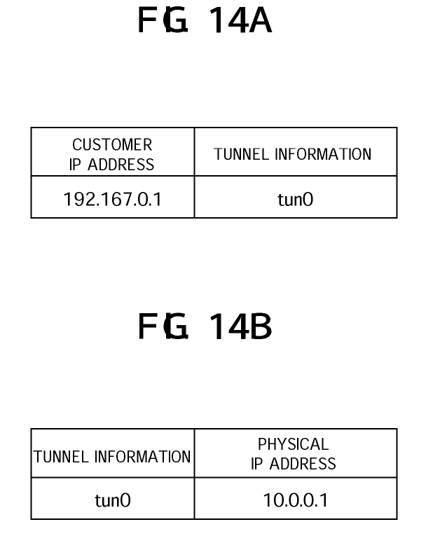

Furthermore, in this example, the settings as illustrated in FIG. 13A and FIG. 13B are made on the routing setting table of the routing section 30A and the tunneling setting table of the tunneling section 30B in the server α, respectively. Still further, the settings as illustrated in FIG. 14A and FIG. 14B are made on the routing setting table of the routing section 30A and the tunneling setting table of the tunneling section 30B in the server γ, respectively.

Then, when the service starting command is received in the service starting command receiving section 10A, the guest OS starting section 10B starts up the guest OS 40 in the server β, and also, makes the service program of service program type A to be executable. At this time, the guest OS starting section 10B allocates the new customer IP address (192.167.0.3) to the started guest OS 40 (step 1). Here, the connection target determining section 10C refers to the connecting course table 10F, to acquire all of the service program types necessary for establishing the VPN connection to the service program type A commanded to be started up, namely, the service program type B (step 2). Further, the connection target determining section 10C refers to the service administration table 10G, to acquire the server in which the guest OS 40 executing the service program of service program type B is operated, namely, the server γ as the connection target server (step 3). Furthermore, the connection information acquiring section 10D acquires the customer IP address (192.167.0.2) of the operated guest OS 40 (step 4).

Further, the connection information acquiring section 10D determines the tunnels to be used for the VPN connection between the server β and the server γ. Herein, the tunnel to be used for the VPN connection from the server β to the server γ is set to “tun0”, whereas the tunnel to be used for the VPN connection from the server γ to the server β is set to “tun1” (step 5). Furthermore, the connection information acquiring section 10D refers to the physical IP address table 10H, to acquire the physical IP address (10.0.0.3) of the server γ (step 6).

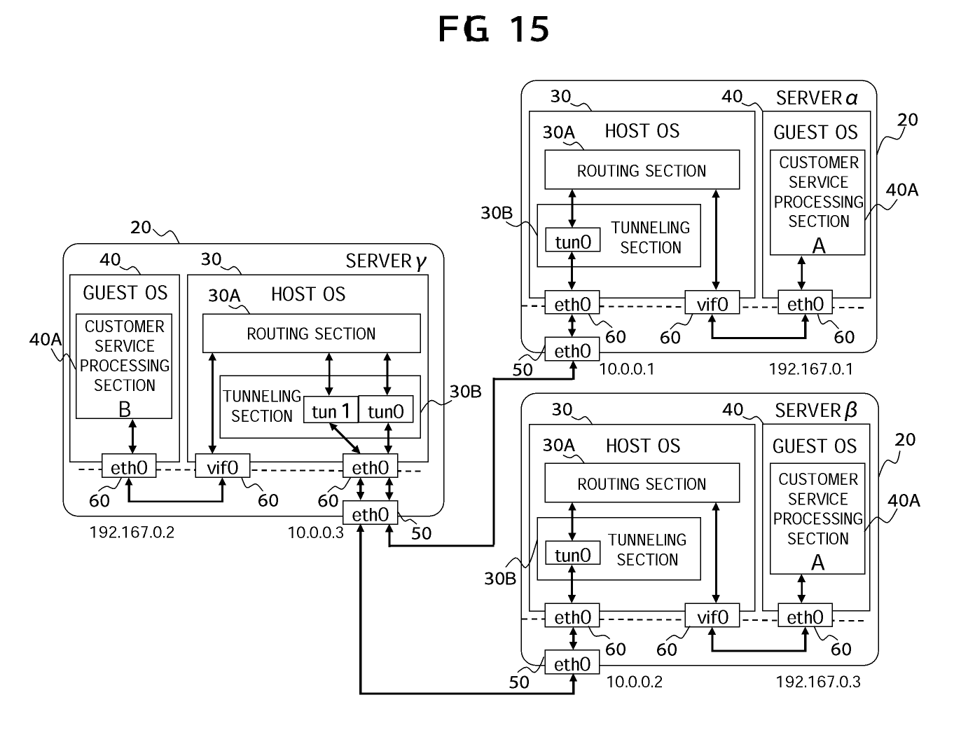

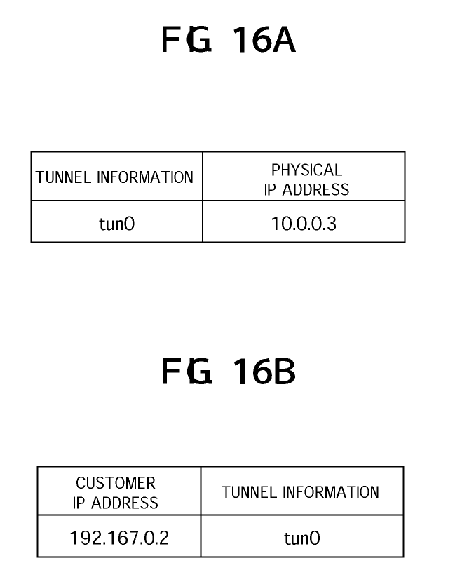

Then, in order to establish the VPN connection from the server β to the server γ, the network setting section 10E sets the new tunnel (tun0) to the tunneling section 30B of the server β, as illustrated in FIG. 15. Further, the network setting section 10E sets the tunnel information (tun0) and the physical IP address (10.0.0.3) of the server γ to the tunneling setting table in the tunneling section 30B of the server β, as illustrated in FIG. 16A (step 7). Still further, the network setting section 10E sets the customer IP address of the server γ and the tunnel information thereof to the routing setting table in the routing section 30A of the server β (step 8).

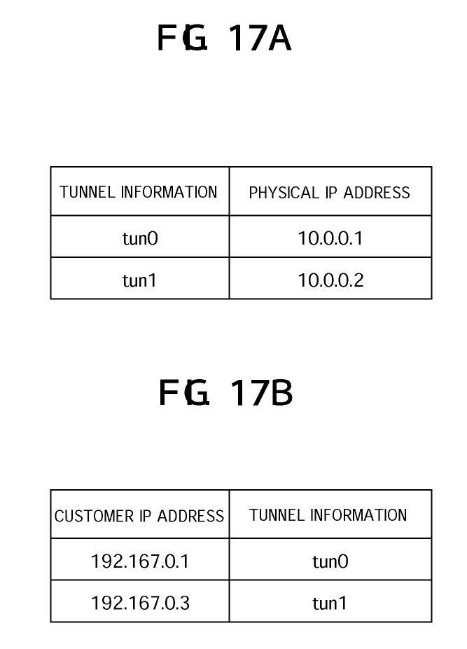

On the other hand, in order to establish the VPN connection from the server γ to the server β, the network setting section 10E sets the new tunnel (tun1) in the tunneling section 30B of the server γ, as illustrated in FIG. 15. Further, the network setting section 10E sets the tunnel information of the new tunnel and the physical IP address of the server β to the tunneling setting table in the tunneling section 30B of the server γ, as illustrated in FIG. 17A (step 9). Furthermore, the network setting section 10E sets the customer IP address of the server β and the tunneling information thereof to the routing setting table in the routing section 30A of the server γ, as illustrated in FIG. 17B (step 10).

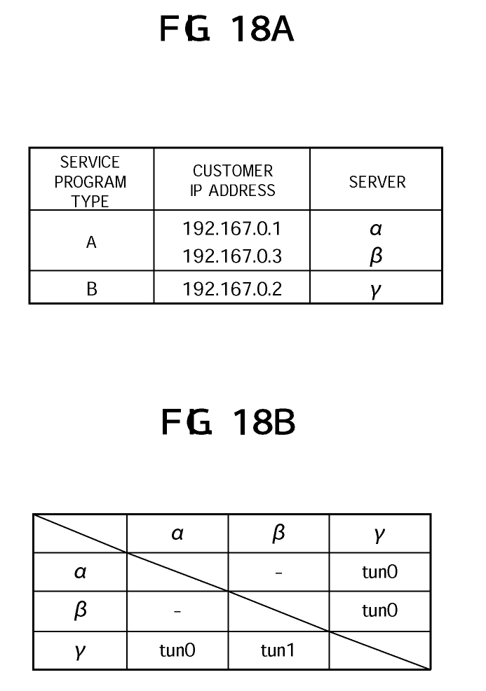

Then, the network setting section 10E registers the server β as the server executing the service program of service program type A, and also, registers the customer IP address (192.167.0.3), in the service administration table 10G of the administrative manager 10, as illustrated in FIG. 18A. Further, the network setting section 10E registers the tunnel information (tun0) from the server β to the server γ and the tunnel information (tun1) from the server γ to the server β in the interface administration table 10I, as illustrated in FIG. 18B (step 11).

According to the network setting process described above, it is set whether or not the connection among the service program types in the connecting course table 10F is available, and also, the servers in which the service programs of respective service program types are executed are set, in the service administration table 10G. Therefore, by referring to these tables, when the guest OS is newly started up, the connection target server can be automatically determined according to the service program to be executed in the newly started guest OS. Further, the customer IP addresses of respective servers are set in the service administration table 10G, and the physical IP addresses of respective servers are set in the physical IP address table. Therefore, by referring to these tables, it is possible to acquire the connection information enabling the VPN connection between the starting objective server and the connection target server, to thereby automatically perform the network setting to each host OS. Accordingly, even when the guest OS is newly started up, the work of specifying the connection target server is omitted, and also, the work of routing setting in each server and the work of tunneling setting for the VPN connection are omitted. Then, a burden in the network setting work is considerably decreased, and also, mistakes during the setting work can be prevented.

Further, as described in the above, it is possible to set whether or not the connection among the service programs of same type to the connecting course table 10F is available. Therefore, as in the above embodiment, in the case where the service program in service program type same as that of the service program already executed is further executed for the transverse development of the function of the specific service program, the present system can be applied. On the other hand, it is also possible to set whether or not the connection among the service programs of different types to the connecting course table 10F is available. Therefore, also in the case of performing the vertical development for newly executing the service program in service program type which has not been executed, if the new service program type is previously registered in the connecting course table 10F, the present system can be applied. Thus, according to the present system, in system expansion in every embodiment, it is possible to automate the network setting work.

All examples and conditional language recited herein are intended for pedagogical purposes to aid the reader in understanding the invention and the concepts contributed by the inventor for furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer readable recording medium storing a network setting program causing a computer, which is connected to a plurality of servers each including a virtual machine environment in which a host operating system that directly performs communications with another server using a virtual network and a guest operating system that is started up to execute a service program for processing a customer's service and performs communications with said another server only via the host operating system, are operable as virtual operating systems, to execute a process comprising:
referring to a table in which whether or not transmission and reception of data among service programs is available is set and a table in which the servers executing the service programs are set when the guest operating system is started up in a server in accordance with an operator instruction, to thereby determine a connection target server which establishes the virtual network connection to the server in which the guest operating system is started up, according to the service program to be executed by the started guest operating system;
acquiring connection information necessary for establishing the virtual network connection between the server in which the guest operating system is started up and the determined connection target server; and
setting the acquired connection information to the host operating system that operates in the server in which the guest operating system is started up and to the host operating system that operates in the connection target server.

2. A computer readable recording medium storing a network setting program causing the computer to execute a process according to claim 1,
wherein a virtual IP address is allocated to the guest operating system in each of the plurality of servers, and based on network setting associated with a physical IP address of a separate server being connection target, the virtual IP address of the guest operating system of the separate server and tunnel information to be used for the virtual network connection to the separate server, the host operating system in each server specifies the physical IP address of the separate server being transmission target from the virtual IP address of the guest operating system of the separate server, which is attached to data transmitted from the guest operating system in the own server to the separate server, and thereafter, performs a tunneling on the data in accordance with the tunnel information to transmit the data, and
wherein the process of acquiring the connection information comprises, referring to a table indicating a relation between each server and the corresponding physical IP address thereof and a table indicating a relation between each server and the corresponding virtual IP address of the guest operating system that operates therein, to acquire the physical IP address of the connection target server and the virtual IP address of the guest operating system in the connection target server, and also, determining a tunnel to be used for virtual network connecting between the server in which the guest operating system is newly started up and the connection target server, to acquire the tunnel information of the determined tunnel.

3. A computer readable recording medium storing a network setting program causing the computer to execute a process according to claim 1,
wherein whether or not transmission and reception of data among the service programs of same service program types and among the service programs of different service program types is available is set to the table in which whether or not transmission and reception of data among the service programs is available is set, according to service program types based on service program functions.

4. A computer readable recording medium storing a network setting program causing the computer to execute a process according to claim 1,
wherein when the connection target server is a plurality of connection target servers, the processes of acquiring the connection information and setting the connection information is performed on all of the plurality of connection target servers.

5. A network setting method executed in a computer, which is connected to a plurality of servers each including a virtual machine environment in which a host operating system that directly performs communications with another server using a virtual network and a guest operating system that is started up to execute a service program for processing a customer's service and performs communications with said another server only via the host operating system, are operable as virtual operating systems, the method comprising:
referring to a table in which whether or not transmission and reception of data among service programs is available is set and a table in which the servers executing the service programs are set when the guest operating system is started up in a server in accordance with an operator instruction, to thereby determine a connection target server which establishes the virtual network connection to the server in which the guest operating system is started up, according to the service program to be executed by the started guest operating system;
acquiring connection information necessary for establishing the virtual network connection between the server in which the guest operating system is started up and the connection target server; and
setting the acquired connection information to the host operating system that operates in the server in which the guest operating system is started up and to the host operating system that operates in the connection target server.

6. A network setting apparatus connected to a plurality of servers each including a virtual machine environment in which a host operating system that directly performs communications with another server using a virtual network; and a guest operating system that is started up to execute a service program for processing a customer's service and performs communications with said another server only via the host operating system, are operable as virtual operating systems, the apparatus comprising:
connection target determining unit for referring to a table in which whether or not transmission and reception of data among service programs is available is set and a table in which the servers executing the service programs are set when the guest operating system is started up in a server in accordance with an operator instruction, to thereby determine the connection target server which establishes the virtual network connection to the server in which the guest operating system is started up, according to the service program to be executed by the started guest operating system;
connection information acquiring unit for acquiring connection information necessary for establishing the virtual network connection between the server in which the guest operating system is started up and the connection target server; and setting unit for setting the acquired connection information to the host operating system that operates in the server in which the guest operating system is started up and to the host operating system that operates in the connection target server.
